(19) United States
(12) Patent Application Publication
(10) Pub. No.: US 2008/0046560 A1
(43) Pub. Date: Feb. 21, 2008

(54) Exchange, exchange control program, exchange control method

(75) Inventors: Katsumi Takada, Kawasaki (JP); Masaki Nirasawa, Kawasaki (JP); Kazuhiro Kaneko, Kawasaki (JP); Masahiro Iwama, Kawasaki (JP); Hirokazu Fukui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/637,170

(22) Filed: Dec. 12, 2006

(30) Foreign Application Priority Data
Aug. 2, 2006 (JP) 2006-210548

(51) Int. Cl. G06F 15/173

(52) U.S. Cl. 709/224

(57) ABSTRACT

There is provided an exchange, an exchange control program, and an exchange control method capable of securing a communication channel when lines are crossed.

An exchange is connected between a terminal and a network. The exchange comprises: a monitor section that monitors a state of the network; and a channel control section that secures, before transmission from the terminal on a call-out side, a channel for use in the transmission from the call-out side terminal when determining that the network state meets a predetermined line condition based on the monitor result of the monitor section and receiving a channel securing instruction from the call-out side terminal.

### BACKGROUND OF THE INVENTION

1. Field of the Invention

The present invention relates to an exchange, an exchange control program, and an exchange control method that perform control of communication when a communication line is congested.

2. Description of the Related Art

In a communication system using telephones, information transmission becomes difficult when lines are crossed.

As a prior art relating to the present invention, there is known an Internet telephone that can select a protocol in accordance with a network congestion state (refer to, e.g., Patent Document 1: Jpn. Pat. Appln. Laid-Open Publication No. 2001-298479).

An exchange has a limited number of channels that can be used at a time. Thus, in the case where lines are crossed, a line busy state occurs even if a user hooks off his or her telephone, with the result that communication is completely disabled. As a matter of course, there exist a lot of information to be surely transmitted even if lines are crossed.

### SUMMARY OF THE INVENTION

The present invention has been made to solve the above problem, and an object thereof is to provide an exchange, an exchange control program, and an exchange control method capable of securing a communication channel when lines are crossed.

To solve the above problem, according to a first aspect of the present invention, there is provided an exchange connected between a terminal and a network, comprising: a monitor section that monitors a state of the network; and a channel control section that secures, before transmission from the terminal on a call-out side, a channel for use in the transmission from the call-out side terminal when determining that the network state meets a predetermined line condition based on the monitor result of the monitor section and receiving a channel securing instruction from the call-out side terminal.

According to a second aspect of the present invention, there is provided an exchange control program allowing a computer to execute control of an exchange connected between a terminal and network, the program comprising: a monitor step that monitors a state of the network; and a channel control step that secures, before transmission from the terminal on a call-out side, a channel for use in the transmission from the call-out side terminal when determining that the network state meets a predetermined line condition based on the monitor result of the monitor step and receiving a channel securing instruction from the call-out side terminal.

According to a third aspect of the present invention, there is provided an exchange control method that controls an exchange connected between a terminal and network, the method comprising: a monitor step that monitors a state of the network; and a channel control step that secures, before transmission from the terminal on a call-out side, a channel for use in the transmission from the call-out side terminal when determining that the network state meets a predetermined line condition based on the monitor result of the monitor step and receiving a channel securing instruction from the call-out side terminal.

According to the present invention, it is possible to secure a communication channel when lines are crossed.

### BRIEF DESCRIPTION OF THE DRAWINGS

FIG. 1 is a block diagram showing an example of a communication system according to an embodiment;

FIG. 2 is a block diagram showing an example of a configuration of a telephone exchange according to the embodiment;

FIG. 3 is a sequence diagram showing an example of the operation of a call-out side in the communication system according to the embodiment; and

FIG. 4 is a sequence diagram showing an example of the operation of a call-in side in the communication system according to the embodiment.

### DETAILED DESCRIPTION OF THE PREFERRED EMBODIMENTS

An embodiment of the present invention will be described below with reference to the accompanying drawings.

Firstly, a configuration of a communication system using a telephone exchange which is an exchange according to the embodiment of the present invention will be described.

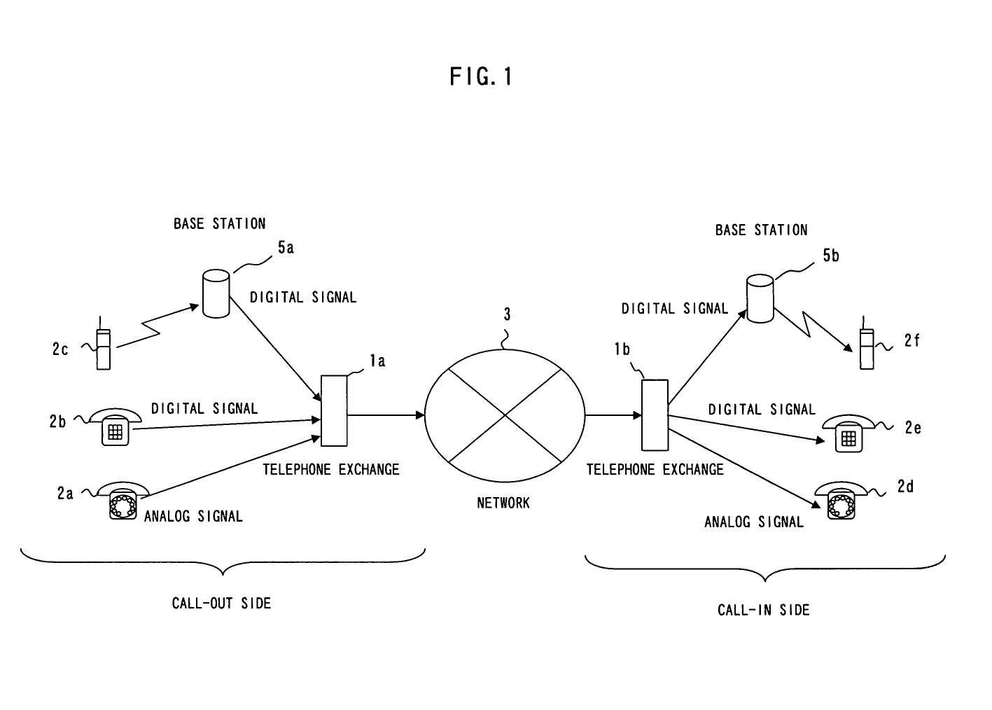

FIG. 1 is a block diagram showing an example of a communication system according to the present embodiment. The communication system shown in FIG. 1 includes telephone exchanges 1a, 1b, telephones (terminals) 2a, 2b, 2c, 2d, 2e, 2f, a network 3, and base stations 5a, 5b. The telephone exchange 1a, telephones 2a, 2b, 2c, and base station 5a are disposed on the call-out side; while the telephone exchange 1b, telephones 2d, 2e, 2f, and base station 5b are disposed on the call-in side.

The telephones 2a and 2d communicate with the telephone exchange 1 via an analog signal. The telephones 2b and 2e communicate with the telephone exchange 1 via a digital signal. The telephones 2c and 2f communicate with the base station 5 via a wireless digital signal. The base station 5 communicates with the telephone exchange 1 via a digital signal. The telephone exchange 1a is connected to the network 3 and telephones 2a, 2b, and 2c. The telephone exchange 1b is connected to the network 3 and telephones 2d, 2e, and 2f. Only some of the telephones 2a to 2f may be used, and a communication terminal using another communication method may be used.

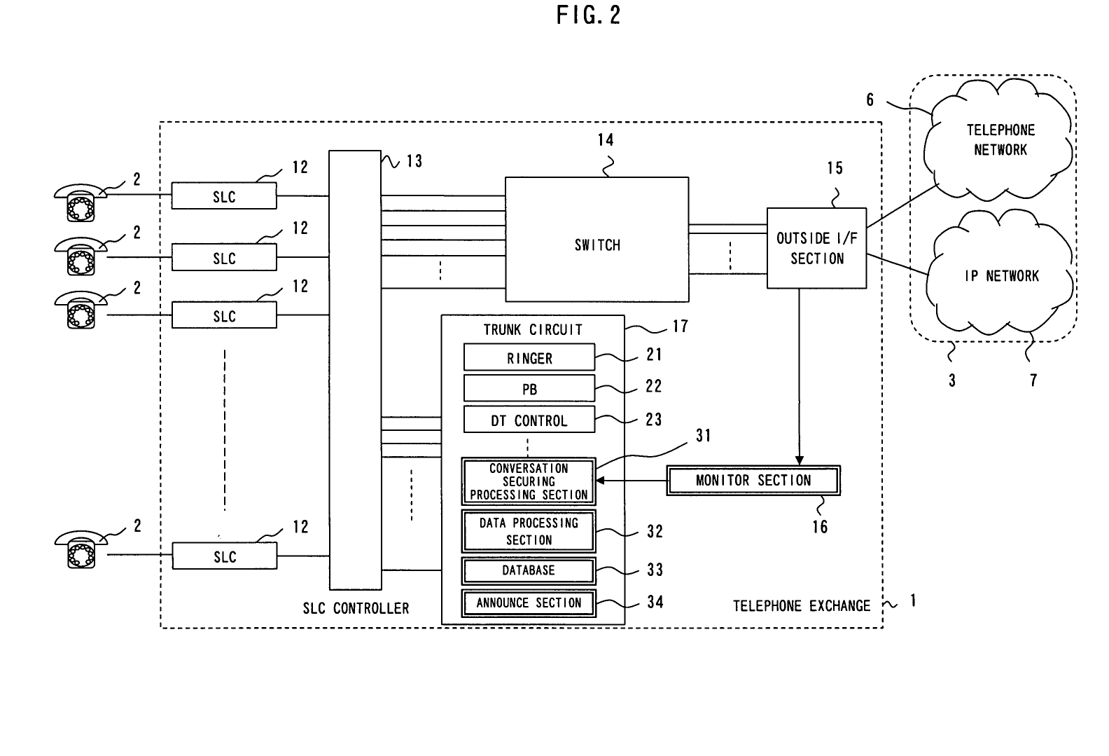

FIG. 2 is a block diagram showing an example of a configuration of the telephone exchange according to the present embodiment. The telephone exchange 1 is connected to the network 3 and plurality of telephones 2. The telephone exchange 1 includes an SLC (Subscriber Line Circuit) 12, an SLC controller 13, a switch 14, an outside I/F section 15, a monitor section 16, and a trunk circuit 17. The network 3 includes a telephone network 6, and an IP (Internet Protocol) network 7. As the network 3, only one of the telephone network 6 and IP network 7 may be used.

The functions of the SLC 12, SLC controller 13, switch 14, and outside I/F section 15 have not been changed compared to a conventional telephone exchange. The SLC 12 has BORSCHT (Battery feed, Over voltage protection, Ringing signal sending, Supervisory, Coder-decoder, Hybrid, Testing) function, and the analog system telephone 2 can also be taken in the digital subscriber line.

The monitor section 16 monitors the line usage rate of the telephone exchange 1 (the ratio of the number of lines being used relative to the number of lines available to the telephone exchange 1 or the ratio of the bandwidth being used relative to the bandwidth available to the telephone exchange 1). The trunk circuit 17 includes a ringer 21, a PB (Push Button) section 22, a DT (Dial Tone) controller 23, a conversation securing processing section 31 (channel controller), a data processing section 32 (data conversion section), a database 33 (data transmission section), and an announce section 34. The functions of the ringer 21, PB section 22, and DT controller 23 have not been changed compared to a conventional telephone exchange.

The functions of the other components in the trunk circuit 17 differ depending on whether the telephone exchange 1 is disposed on the call-out side or call-in side. The conversation securing processing section 31 executes a conversation securing mode on the call-out side; while issues an acknowledgement on the call-in side. The data processing section 32 compresses transmission data into compressed data on the call-out side; while restores the transmission data from the compressed data on the call-in side. The database 33 stores or deletes the compressed data on the call-out side. The announce section 34 announces, on the call-in side, date or sender name included in the transmission data to the telephone 2 disposed on the call-in side.

Next, operation of the communication system according to the present embodiment will be described.

When lines are crossed, the call-out side telephone exchange (telephone exchange 1) uses the conversation securing processing section 31 to execute the conversation securing mode and uses the data processing section 32 to perform data compression to reduce traffic load of each channel, thereby securing the number of calls connected or resources (channels) on the IP network to increase the number of channels that can be used at a time. Further, the call-out side telephone exchange stores data in the database 33 and, if transmission data has not reached the call-in side due to call loss, retransmits the data. For example, when lines are crossed, the call-out side telephone exchange uses 1% of the available bandwidth to execute the conversation securing mode to compress transmission data in the conversation securing mode into 1/100 its volume, thereby substantially doubling the number of channels that can be used at a time as compared to that in normal time. A configuration in which an extra frequency band is prepared for the telephone exchange 1 and the telephone exchange 1 uses the prepared frequency band only at the execution time of the conversation securing mode may be employed.

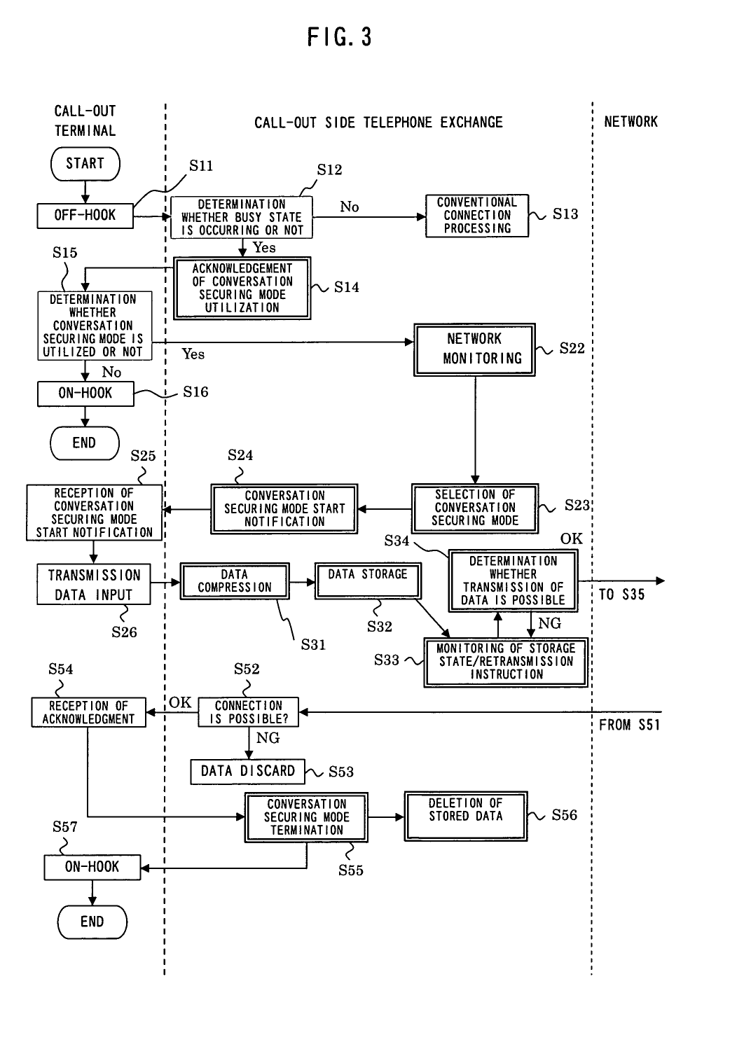

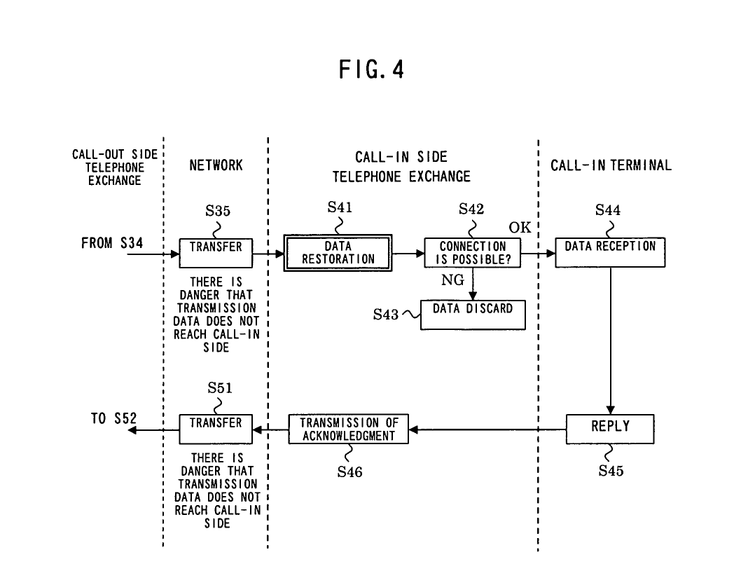

FIG. 3 is a sequence diagram showing an example of the operation of the call-out side (call-out terminal, i.e., call-out side telephone 2 and call-out side telephone exchange, i.e., telephone exchange 1 connected to call-out side telephone 2) in the communication system according to the present embodiment. FIG. 4 is a sequence diagram showing an example of the operations of the network 3 and call-in side (call-in side telephone exchange, i.e., telephone exchange 1 connected to call-in side telephone 2 and call-in terminal, i.e., call-in side telephone 2) in the communication system according to the present embodiment.

When the call-out terminal goes off-hook to originate a call to the call-out side telephone exchange (S11), the SLC controller 13 of the call-out side telephone exchange determines whether a busy state is occurring or not (S12). The SLC controller 13 determines that a busy state is occurring if the line usage rate detected by the monitor section 16 exceeds a predetermined threshold. If a busy state is not occurring (No in S12), the SLC controller 13 performs connection processing to the network 3 in the same manner as a conventional telephone exchange (S13). If a busy state is occurring (Yes in S12), the conversation securing processing section 31 transmits to the call-out terminal a request for confirmation of conversation securing mode utilization for obtaining confirmation of utilization of the conversation securing mode together with a busy tone (S14). Then, the call-out terminal prompts a user to check whether to utilize the conversation securing mode or not according to the request for confirmation of conversation securing mode utilization transmitted from the call-out side telephone exchange and determines whether the confirmation of utilization of the conversation securing mode has been obtained or not (S15).

If confirmation of utilization of the conversation securing mode has not been obtained from the user (No in S15), the call-out terminal goes on-hook (S16), and this flow is ended. On the other hand, if confirmation of utilization of the conversation securing mode has been obtained from the user (Yes in S15), the call-out terminal transmits conversation securing mode utilization confirmation to the call-out side telephone exchange. Then, the monitor section 16 monitors the network state to acquire the line usage rate (S22), and the conversation securing processing section 31 selects an adequate conversation securing mode based on the acquired line usage rate, data amount and distance from the call-out terminal, and a protocol used (S23). In the conversation securing mode, a data compression method, line (channel on the telephone network 6 or IP network 7), and frequency band to be used, etc., are specified.

At this time, the conversation securing processing section 31 selects, as a line to be used, e.g., a line with a low usage rate (a line which is not congested), a line with a broader frequency band, or a line with a small delay. The conversation securing processing section 31 determines a frequency band in accordance with the data amount to be transmitted. The conversation securing processing section 31 uses, e.g., one of the following first to third data compression methods.

In the first data compression method, if a voice signal from the telephone 2 is an analog signal, the data processing section 32 performs an A/D conversion to convert the analog voice signal into voice data (digital signal) and performs compression coding for the voice data to obtain compressed data. In the second data compression method, the data processing section 32 performs voice recognition for a voice signal or voice data from the telephone 2 to convert the signal or data into text data which is compressed data. In a third data compression method, the data processing section 32 notifies the call-out terminal of prepared fixed phrase candidates to prompt the user of the call-out terminal to select one of the choices and obtains a selected number of the fixed phrase as compressed data. The fixed phrase is a sentence to respond a situation (e.g., confirmation about the safety of interested parties in case of an emergency) where lines are easily crossed and therefore is a minimum sentence that needs to be transmitted. By using the above data compression methods, it is possible to significantly reduce the frequency band for each channel in the conversation securing mode as compared to that in normal time.

Then, the conversation securing processing section 31 issues a start notification of a conversation securing mode selected by the monitor section 16 to the call-out terminal (S24). The conversation securing processing section 31 may arbitrarily start the conversation securing mode without obtaining the confirmation of utilization of the conversation securing mode from the user and, after that, transmit the conversation securing mode start notification to the call-out terminal.

After receiving the conversation securing mode start notification (S25), the call-out terminal receives an input of transmission data (voice or data) from the user and transmits the input data to the call-out side telephone exchange (S26). Then the data processing section 32 adds basic information such as name of a sender or date information to the transmission data from the call-out terminal and performs data compression for the transmission data according to the data compression method in the current conversation securing mode (S31). The database 33 stores the compressed data obtained as a result of the data compression (S32). Then the monitor section 16 starts monitoring whether any compressed data exists in the database 33 (S33) and determines whether the compressed data can be transmitted to the network 3 via a line in the conversation securing mode (S34). If the data transmission is not possible (NG in S34), the monitor section 16 returns to step S33 after a predetermined time has elapsed and makes determination once again. On the other hand, the data transmission is possible (OK in S34), the outside I/F section 15 reads in compressed data stored in the database 33 and transmits the compressed data to the call-in side telephone exchange via the network 3 (S35).

When detecting that any compressed data exists in the database 33 after a predetermined time has passed from step S33, the monitor section 16 determines that the compressed data has not been normally transmitted due to call loss or the like and instructs the outside I/F section 15 to retransmit the compressed data.

Then, after receiving the compressed data via the network 3, the data processing section 32 of the call-in side telephone exchange restores the transmission data from the compressed data (S41). Then, the announce section 34 announces the basic information included in the transmission data to the call-in terminal, and the SLC controller 13 determines whether it can be connected to the call-in terminal (S42). If the connection is not possible (NG in S42), the SLC controller 13 discards the transmission data (S43). On the other hand, if the connection is possible (OK in S42), the SLC controller 13 transmits the transmission data to the call-in terminal. Then, the call-in terminal receives the transmission data (S44) and transmits a reply indicating that the data has been received, to the call-in side telephone exchange (S45). Upon receiving the reply, the conversation securing processing section 31 of the call-in side telephone exchange issues an acknowledgment (S46) and transmits it to the call-out side telephone exchange via the network 3 (S51).

Upon receiving the acknowledgment, the SLC controller 13 of the call-out side telephone exchange determines whether it can be connected to the call-out terminal (S52). If the connection is not possible (NG in S52), the SLC controller 13 discards the acknowledgment (S53). On the other hand, if the connection succeeds (OK in S52), the SLC controller 13 transmits the acknowledgment to the call-out terminal. The call-out terminal receives the acknowledgment and transmits a reply indicating that the acknowledgment has been received to the call-out side telephone terminal (S54). Upon receiving the reply, the conversation securing processing section 31 of the call-out side telephone terminal terminates the conversation securing mode, transmits a conversation securing mode termination notification to the call-out terminal (S55), and deletes the compressed data stored in the database 33 (S56). Upon receiving the conversation securing mode termination notification, the call-out terminal goes on-hook (S57), and this flow is ended.

Note that the data compression may be performed not by the data processing section 32 of the call-out side telephone exchange but by the call-out terminal, and the data restoration may be performed not by the data processing section 32 of the call-in side telephone exchange but by the call-in terminal.

According to the present embodiment, when lines are crossed, transmission data is compressed on the call-out side and restored on the call-in side. As a result, a communication channel can be secured using limited resources, thereby avoiding a conversation disabled state. Further, the configuration in which the call-in terminal notifies the call-out terminal that the transmission data has been received allows reliable communication. Further, by applying the conversation securing mode in case of disaster or the like, important information such as confirmation of the safety of interested parties can reliably be performed.

A monitor step corresponds to steps S22 and S33 in the embodiment. A channel control step corresponds to steps S23 and S24 in the embodiment. A data conversion step corresponds to step S31 in the embodiment. A data transmission step corresponds to steps S32, S33, and S34 in the embodiment. A data restoration step corresponds to step S41 in the embodiment.

Further, it is possible to provide a program that allows a computer constituting the exchange to execute the above steps as an exchange control program. By storing the above program in a computer-readable storage medium, it is possible to allow the computer constituting the exchange to execute the program. The computer-readable storage medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

What is claimed is:

1. An exchange connected between a terminal and a network, comprising:
a monitor section that monitors a state of the network; and
a channel control section that secures, before transmission from the terminal on a call-out side, a channel for use in the transmission from the call-out side terminal when determining that the network state meets a predetermined line condition based on the monitor result of the monitor section and receiving a channel securing instruction from the call-out side terminal.

2. The exchange according to claim 1, further comprising a data conversion section that converts transmission data from the call-out side terminal into compressed data based on an instruction from the channel control section.

3. The exchange according to claim 1, wherein
the channel control section instructs the call-out side terminal to compress transmission data and receives data compressed by the call-out side terminal.

4. The exchange according to claim 1, further comprising a data transmission section that stores the compressed data and transmits the compressed data to a channel secured by the channel control section.

5. The exchange according to claim 4, wherein
the monitor section determines whether the compressed data has been received by a call-in side terminal, and
in the case where the monitor section determines that compressed data has not been received by the call-in side terminal, the data transmission section retransmits the compressed data stored therein.

6. The exchange according to claim 4, wherein
when receiving compressed data from the network, the data conversion section restores the transmission data from the compressed data and transmits the transmission data to the call-in side terminal.

7. The exchange according to claim 1, wherein
the predetermined line condition is that the line usage rate exceeds a predetermined threshold.

8. An exchange control program allowing a computer to execute control of an exchange connected between a terminal and network, the program comprising:
a monitor step that monitors a state of the network; and
a channel control step that secures, before transmission from the terminal on a call-out side, a channel for use in the transmission from the call-out side terminal when determining that the network state meets a predetermined line condition based on the monitor result of the monitor step and receiving a channel securing instruction from the call-out side terminal.

9. The exchange control program according to claim 8, further comprising a data conversion step that converts transmission data from the call-out side terminal into compressed data based on an instruction from the channel control step.

10. The exchange control program according to claim 8, wherein
the channel control step instructs the call-out side terminal to compress transmission data and receives data compressed by the call-out side terminal.

11. The exchange control program according to claim 8, further comprising a data transmission step that stores the compressed data and transmits the compressed data to a channel secured by the channel control step.

12. The exchange control program according to claim 11, wherein
the monitor step determines whether the compressed data has been received by a call-in side terminal, and
in the case where the monitor step determines that compressed data has not been received by the call-in side terminal, the data transmission step retransmits the compressed data stored therein.

13. The exchange control program according to claim 11, further comprising a data restoration step that receives compressed data from the network, restores the transmission data from the compressed data, and transmits the transmission data to the call-in side terminal.

14. The exchange control program according to claim 8, wherein
the predetermined line condition is that the line usage rate exceeds a predetermined threshold.

15. An exchange control method that controls an exchange connected between a terminal and network, the method comprising:
a monitor step that monitors a state of the network; and
a channel control step that secures, before transmission from the terminal on a call-out side, a channel for use in the transmission from the call-out side terminal when determining that the network state meets a predetermined line condition based on the monitor result of the monitor step and receiving a channel securing instruction from the call-out side terminal.

16. The exchange control method according to claim 15, further comprising a data conversion step that converts transmission data from the call-out side terminal into compressed data based on an instruction from the channel control step.

17. The exchange control method according to claim 15, wherein
the channel control step instructs the call-out side terminal to compress transmission data and receives data compressed by the call-out side terminal.

18. The exchange control method according to claim 15, further comprising a data transmission step that stores the compressed data and transmits the compressed data to a channel secured by the channel control step.

19. The exchange control method according to claim 18, wherein
the monitor step determines whether the compressed data has been received by a call-in side terminal, and
in the case where the monitor step determines that compressed data has not been received by the call-in side terminal, the data transmission step retransmits the compressed data stored therein.

20. The exchange control method according to claim 18, further comprising a data restoration step that receives compressed data from the network, restores the transmission data from the compressed data, and transmits the transmission data to the call-in side terminal.
